(19) United States
(12) Patent Application Publication
(10) Pub. No.: US 2007/0164174 A1
(43) Pub. Date: Jul. 19, 2007

(54) Combination stand for shelf

(76) Inventors: Hsiang-Chuan Hung, Changhua City (TW); Pi-Liang Wang, Changhua City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/451,011

(22) Filed: Jun. 12, 2006

(30) Foreign Application Priority Data
Jan. 10, 2006 (TW) 095200531

(51) Int. Cl. F16M 13/00

(52) U.S. Cl. 248/159

(57) ABSTRACT

A combination stand includes a primary tube having an end portion integrally formed with a mounting portion, and a secondary tube having an end portion detachably mounted on the mounting portion of the primary tube. Thus, the mounting portion has an outer diameter smaller than an inner diameter of the secondary tube, so that the secondary tube is directly mounted on the mounting portion so as to assemble the combination stand easily and quickly. In addition, the secondary tube is directly mounted on the mounting portion so as to assemble the combination stand without needing to provide other parts, so that the combination stand has a simplified construction, thereby decreasing the costs of fabrication.

### BACKGROUND OF THE INVENTION

1. Field of the Invention

The present invention relates to a combination stand and, more particularly, to a combination stand for a shelf.

2. Description of the Related Art

A conventional combination stand in accordance with the prior art shown in FIGS. 7-9 comprises two spaced tubes 30, and a connecting member 40 mounted between the two tubes 30. Each of the two tubes 30 has an end portion 31 rested on the connecting member 40. Each of the two tubes 30 has an inner wall formed with a plurality of annular flanges 33 and an outer wall formed with a plurality of annular grooves 32 each corresponding to the respective annular flange 33. The connecting member 40 has a peripheral wall formed with an opening 41 to make the connecting member 40 flexible. However, the combination stand needs to additionally provide the connecting member 40 between the two tubes 30, so that the combination stand has a complicated construction, thereby increasing the costs of fabrication.

### BRIEF SUMMARY OF THE INVENTION

In accordance with the present invention, there is provided a combination stand, comprising a primary tube having an end portion integrally formed with a mounting portion, and a secondary tube connected to the primary tube and having an end portion detachably mounted on the mounting portion of the primary tube.

The primary objective of the present invention is to provide a combination stand, wherein the mounting portion of the primary tube has an outer diameter smaller than an inner diameter of the secondary tube, so that the secondary tube is directly mounted on the mounting portion of the primary tube so as to assemble the combination stand easily and quickly.

Another objective of the present invention is to provide a combination stand, wherein each of the annular flanges of the secondary tube has an inner diameter smaller than the outer diameter of the mounting portion of the primary tube, so that the mounting portion of the primary tube is pressed by the annular flanges of the secondary tube when the secondary tube is mounted on the mounting portion of the primary tube, and the secondary tube is fitted onto the mounting portion of the primary tube closely and exactly.

A further objective of the present invention is to provide a combination stand, wherein by provision of the slit, the mounting portion of the primary tube has an outwardly elastic force applied on the annular flanges of the secondary tube, so that the secondary tube is mounted on the mounting portion of the primary tube rigidly and stably.

A further objective of the present invention is to provide a combination stand, wherein the secondary tube is directly mounted on the mounting portion of the primary tube so as to assemble the combination stand without needing to provide other parts, so that the combination stand has a simplified construction, thereby decreasing the costs of fabrication.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a combination stand in accordance with the preferred embodiment of the present invention.

FIG. 2 is an exploded perspective view of the combination stand as shown in FIG. 1.

FIG. 3 is a partially plan cross-sectional view of the combination stand as shown in FIG. 1.

FIG. 4 is a perspective view of the combination stand for a shelf as shown in FIG. 1.

FIG. 5 is an exploded perspective view of a combination stand in accordance with another preferred embodiment of the present invention.

FIG. 6 is a partially plan cross-sectional view of the combination stand as shown in FIG. 5.

FIG. 7 is a perspective view of a conventional combination stand in accordance with the prior art.

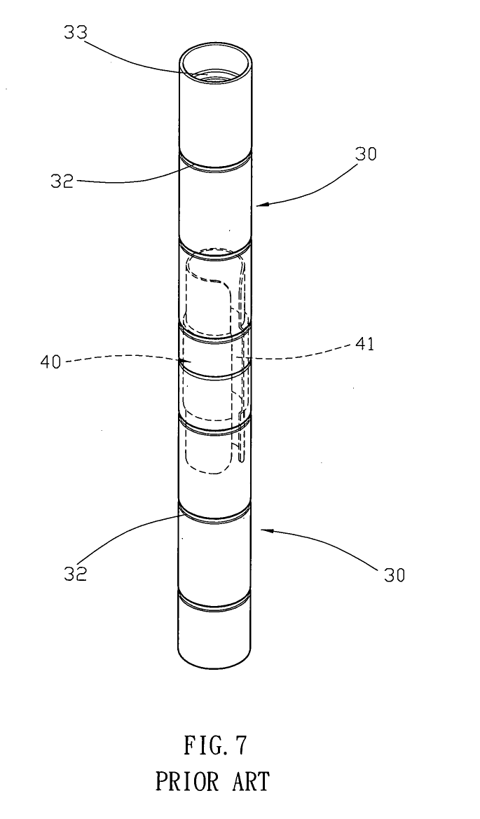

FIG. 8 is an exploded perspective view of the conventional combination stand as shown in FIG. 7.

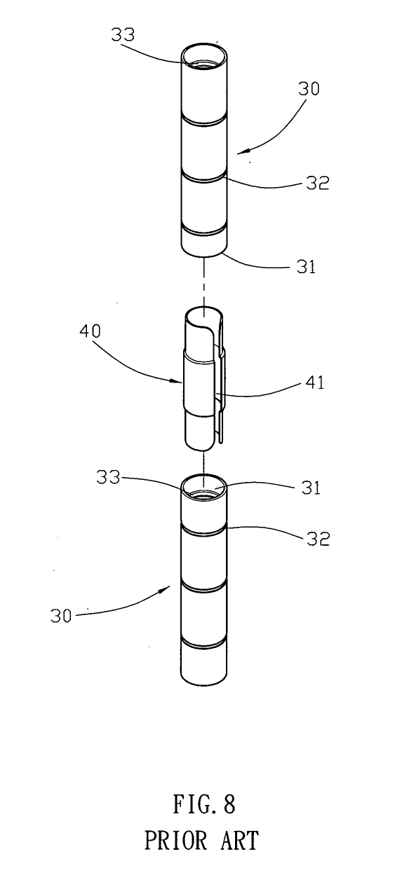

FIG. 9 is a partially plan cross-sectional view of the conventional combination stand as shown in FIG. 7.

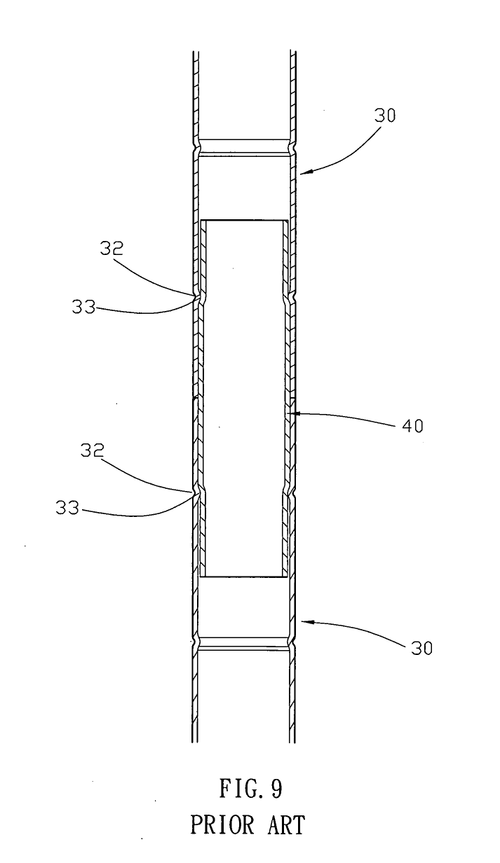

### DETAILED DESCRIPTION OF THE INVENTION

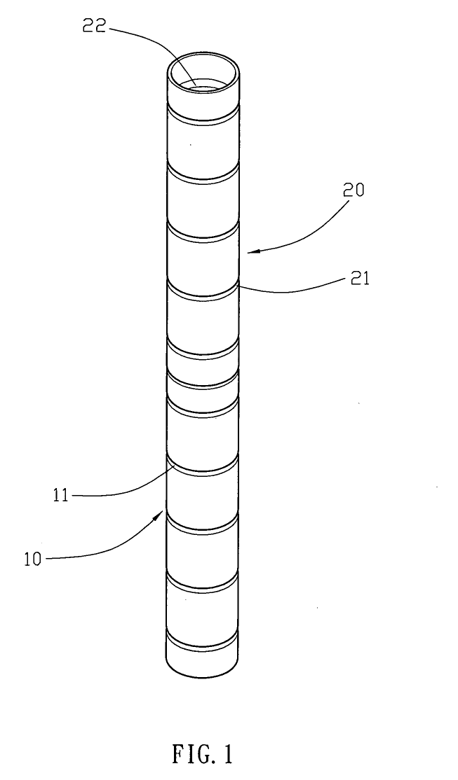

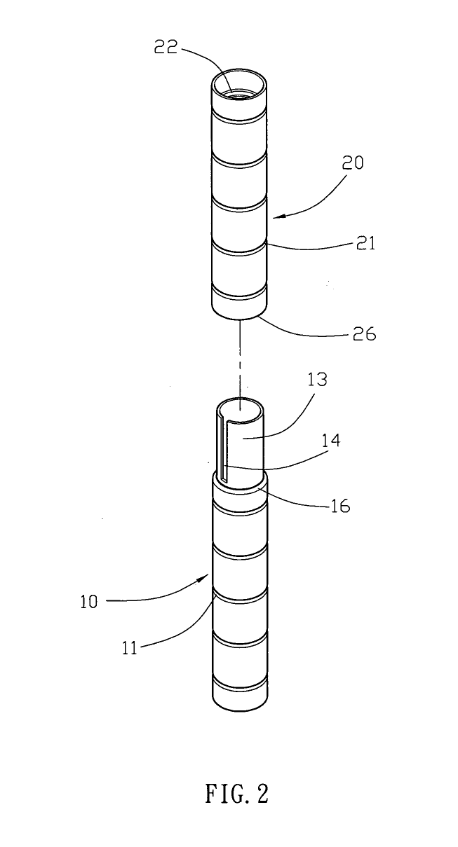

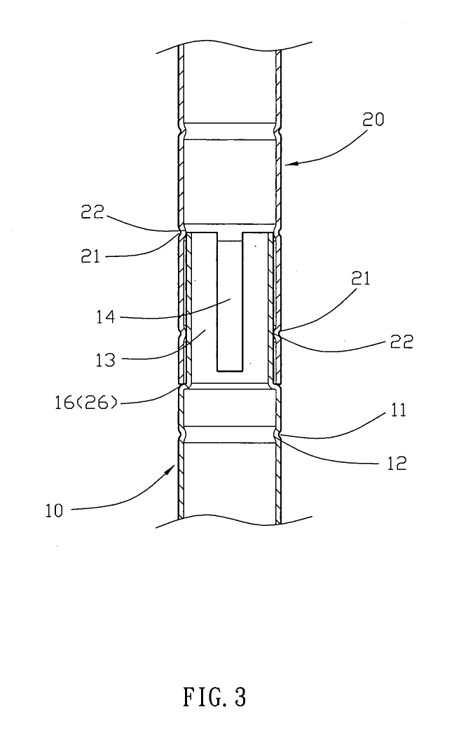

Referring to the drawings and initially to FIGS. 1-3, a combination stand in accordance with the preferred embodiment of the present invention comprises a primary tube 10 having an end portion integrally formed with a mounting portion 13, and a secondary tube 20 connected to the primary tube 10 and having an end portion detachably mounted on the mounting portion 13 of the primary tube 10.

The primary tube 10 has an inner wall formed with a plurality of annular flanges 12 and an outer wall formed with a plurality of annular grooves 11 each corresponding to the respective annular flange 12. The primary tube 10 has an annular shoulder 16 located between the end portion of the primary tube 10 and the mounting portion 13. The mounting portion 13 of the primary tube 10 has a cylindrical shape and has an outer diameter smaller than an inner diameter of the secondary tube 20. The mounting portion 13 of the primary tube 10 has a peripheral wall formed with an axially extending slit 14.

The secondary tube 20 has an inner wall formed with a plurality of annular flanges 22 and an outer wall formed with a plurality of annular grooves 21 each corresponding to the respective annular flange 22. Each of the annular flanges 22 of the secondary tube 20 has an inner diameter smaller than the outer diameter of the mounting portion 13 of the primary tube 10. The end portion of the secondary tube 20 is formed with a resting edge 26 rested on the annular shoulder 16 of the primary tube 10.

Accordingly, the mounting portion 13 of the primary tube 10 has an outer diameter smaller than an inner diameter of the secondary tube 20, so that the secondary tube 20 is directly mounted on the mounting portion 13 of the primary tube 10 so as to assemble the combination stand easily and quickly. In addition, each of the annular flanges 22 of the secondary tube 20 has an inner diameter smaller than the outer diameter of the mounting portion 13 of the primary tube 10, so that the mounting portion 13 of the primary tube 10 is pressed by the annular flanges 22 of the secondary tube 20 when the secondary tube 20 is mounted on the mounting portion 13 of the primary tube 10, and the secondary tube 20 is fitted onto the mounting portion 13 of the primary tube 10 closely and exactly. Further, by provision of the slit 14, the mounting portion 13 of the primary tube 10 has an outwardly elastic force applied on the annular flanges 22 of the secondary tube 20, so that the secondary tube 20 is mounted on the mounting portion 13 of the primary tube 10 rigidly and stably. Further, the secondary tube 20 is directly mounted on the mounting portion 13 of the primary tube 10 so as to assemble the combination stand without needing to provide other parts, so that the combination stand has a simplified construction, thereby decreasing the costs of fabrication.

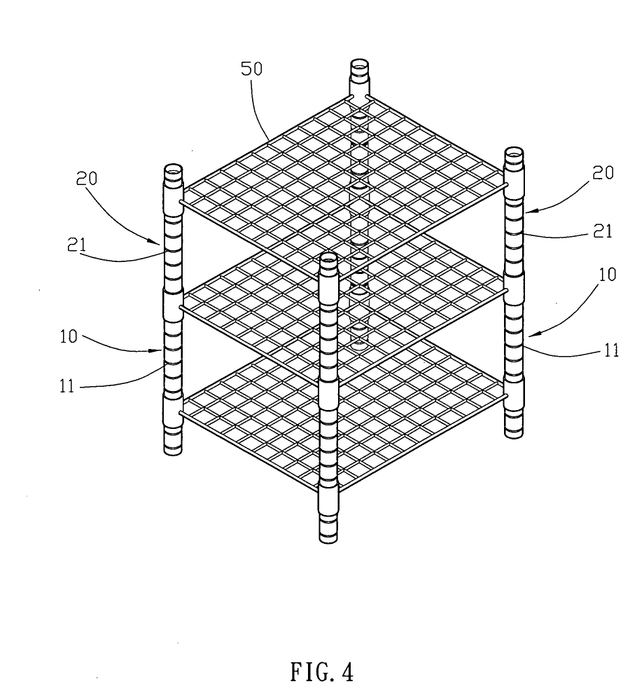

As shown in FIG. 4, a plurality of combination stands are combined with a plurality of support plates 50 to form a shelf.

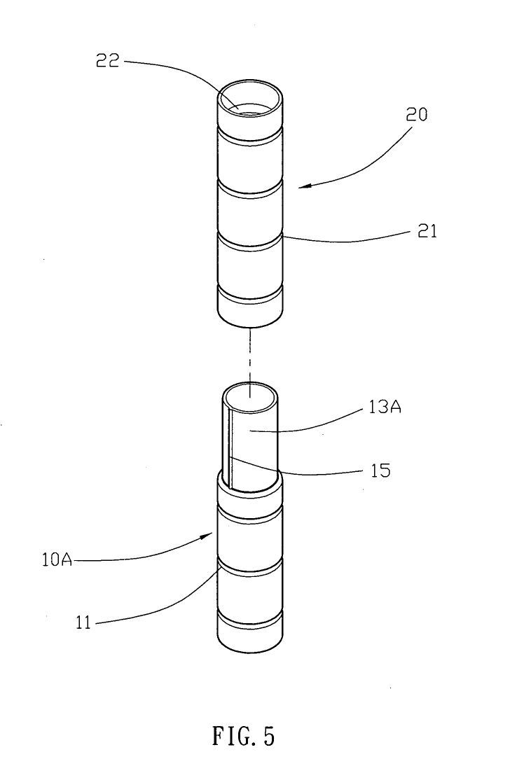

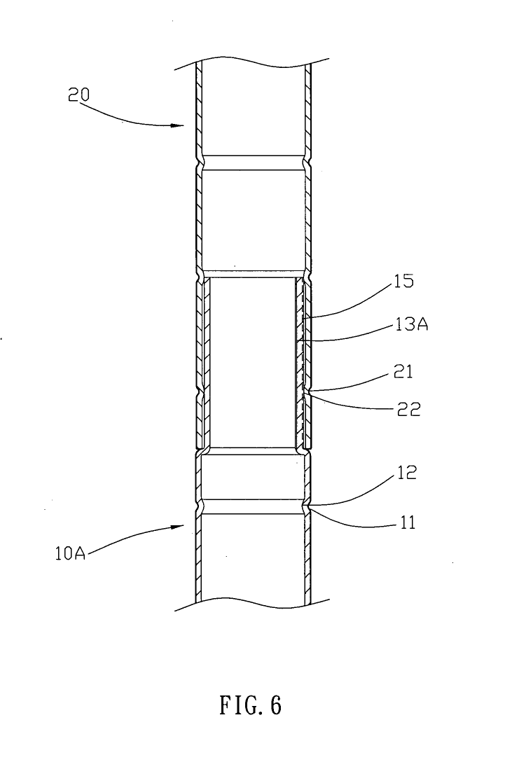

As shown in FIGS. 5 and 6, the mounting portion 13A of the primary tube 10A has an outer wall formed with an axially extending rib 15 pressed by the annular flanges 22 of the secondary tube 20 when the secondary tube 20 is mounted on the mounting portion 13A of the primary tube 10A, so that the secondary tube 20 is fitted onto the mounting portion 13A of the primary tube 10A closely and exactly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A combination stand, comprising:
a primary tube having an end portion integrally formed with a mounting portion;
a secondary tube connected to the primary tube and having an end portion detachably mounted on the mounting portion of the primary tube.

2. The combination stand in accordance with claim 1, wherein the mounting portion of the primary tube has an outer diameter smaller than an inner diameter of the secondary tube.

3. The combination stand in accordance with claim 1, wherein the mounting portion of the primary tube has a peripheral wall formed with an axially extending slit.

4. The combination stand in accordance with claim 1, wherein the secondary tube has an inner wall formed with a plurality of annular flanges each having an inner diameter smaller than an outer diameter of the mounting portion of the primary tube.

5. The combination stand in accordance with claim 4, wherein the secondary tube has an outer wall formed with a plurality of annular grooves each corresponding to the respective annular flange.

6. The combination stand in accordance with claim 1, wherein the primary tube has an annular shoulder located between the end portion of the primary tube and the mounting portion, and the end portion of the secondary tube is formed with a resting edge rested on the annular shoulder of the primary tube.

7. The combination stand in accordance with claim 4, wherein the mounting portion of the primary tube is pressed by the annular flanges of the secondary tube when the secondary tube is mounted on the mounting portion of the primary tube.

8. The combination stand in accordance with claim 1, wherein the mounting portion of the primary tube has an outwardly elastic force applied on the annular flanges of the secondary tube by provision of the slit.

9. The combination stand in accordance with claim 1, wherein the mounting portion of the primary tube has a cylindrical shape.

10. The combination stand in accordance with claim 1, wherein the primary tube 10 has an inner wall formed with a plurality of annular flanges and an outer wall formed with a plurality of annular grooves each corresponding to the respective annular flange.

11. The combination stand in accordance with claim 1, wherein the mounting portion of the primary tube has an outer wall formed with an axially extending rib pressed by the annular flanges of the secondary tube when the secondary tube is mounted on the mounting portion of the primary tube.
